(19) United States
(12) Patent Application Publication
(10) Pub. No.: US 2003/0154613 A1
(43) Pub. Date: Aug. 21, 2003

(54) Differential bending and/or subsidence detector and method for monitoring a structure

(76) Inventor: Bernard Hodac, Paris (FR)

Correspondence Address: YOUNG & THOMPSON, 745 SOUTH 23RD STREET 2ND FLOOR, ARLINGTON, VA, 22202

(21) Appl. No.: 10/257,769

(22) PCT Filed: Apr. 17, 2001
(86) PCT No.: PCT/FR01/01169

(51) Int. Cl. G01B 3/56

(52) U.S. Cl. 33/534

(57) ABSTRACT

The invention concerns a method whereby a succession of elements (1) designed to be placed against the structure to be monitored by pressing the baseplate (4) of each element against a surface of the structure. The elements (1) are linked by articulations (2) and the mutual angular deflection of the elements (1) is read by sensing devices (19). The signal from the sensors is processed by a processing unit (29). The invention is useful for very simple installation of an essentially prefabricated and pre-cabled detector.

This invention relates to a differential bending and/or subsidence detector.

This invention also relates to a method for monitoring the differential bending and/or subsidence of a structure.

This invention is more particularly directed to certain types of differential deformations encountered in geotechnics, and changes of shapes in the tunnels, for a follow-up of the geometrical stability of the structures.

The expression “differential subsidence” designates a strain or deformation such as that of the surface of ground which sinks unequally from one point to the other, this example being not limitative at all.

WO-A-97/42 463 discloses a method consisting in intimately associating to a structure an elongate body, a so-called “model”, in which at least one optical fibre is embedded. when the structure is deformed the model follows the deformation. The deformation of the model is detected by a variation in the attenuation of the light transmitted by the optical fibre.

This method provides a detection which is a so-called “long-base detection”. This means that the interest is directed not to the local deformations but to a cumulation of deformations affecting the structure along the model or even, by way of extrapolation, along the whole corresponding length of the structure itself when the model does not entirely cover said length.

The preliminary installation steps which are needed for implementation of the known method are relatively extensive on the site. They also require, in many cases, a certain accuracy, especially as far as positioning of the optical fibre(s) within the model is concerned.

The object of this invention is to provide a detector and a method which be easier to install and capable of providing more localised results

According to the invention, the differential bending and/or subsidence detector is characterised by comprising:

a sequence of at least two elements connected to each other by linking means, said sequence being intended to be mounted so as to match a profile of a surface of the structure the differential bending and/or subsidence of which is to be detected; and

a detection means for detecting the relative angular deflection between adjacent elements.

The detector according to the invention is remarkably simple to install since it is merely needed to secure the detector onto the surface of the structure to be monitored. In extreme cases, for example when mere structure clamps are used for performing installation of the detector in a fixed manner, or even if one merely causes the detector to rest on the top of the surface, the installation may be achieved in a few tens seconds. This is important in certain applications, for example in environments which are liable to be radioactive.

The detector according to the invention delivers a signal corresponding to the angle formed between successive elements at each link. It is possible to draw therefrom information upon the local deformations and an image of the deformed structure. It is however also possible, as with the known long-base detection, to calculate the cumulated deformation over a certain length. The long-base measurement is based on the recognition that for civil engineering buildings, an integral (in the mathematical meaning of this term ) of the strains is more representative of the risk to which the structure is exposed rather than this or that strain measured locally.

According to a second aspect of the invention, the method for monitoring the differential bending and/or subsidence of a structure, is characterised by positioning along at least part of a surface of the structure several successive elements connected to each other by linking means, and detecting angular deflections between successive elements.

Other features on advantages of the invention will appear from the following description, relating to non-limiting examples.

In the appended drawings:

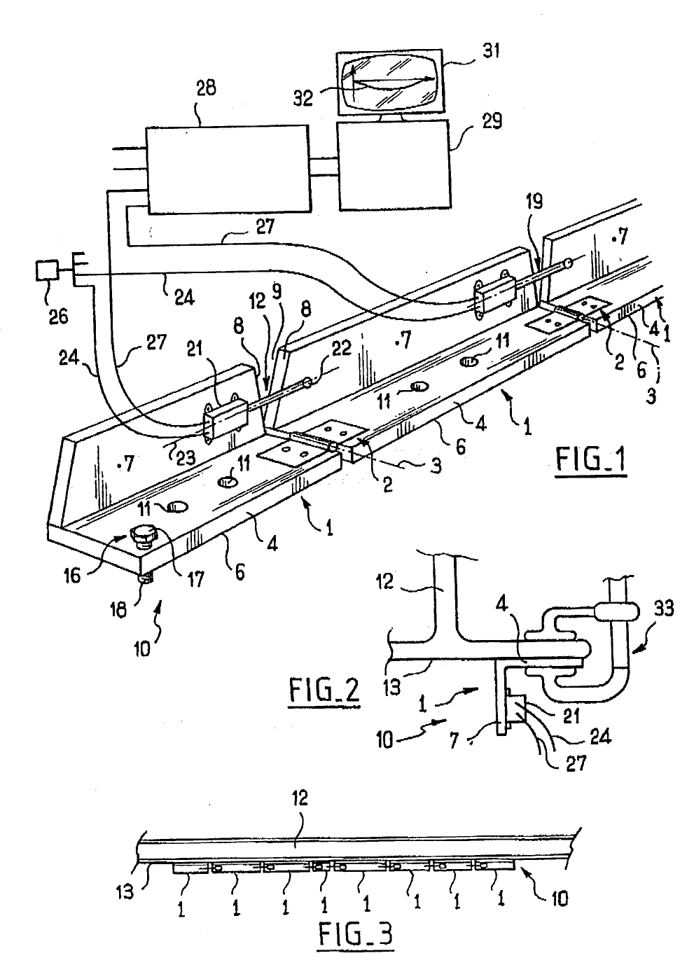

FIG. 1 is a diagrammatic perspective view of the differential bending and/or subsidence detector according to the invention;

FIG. 2 illustrates the quick mounting mode of the detector beneath beam being part of a structure to be monitored;

FIG. 3 is an elevational view of a detector secured beneath the beam;

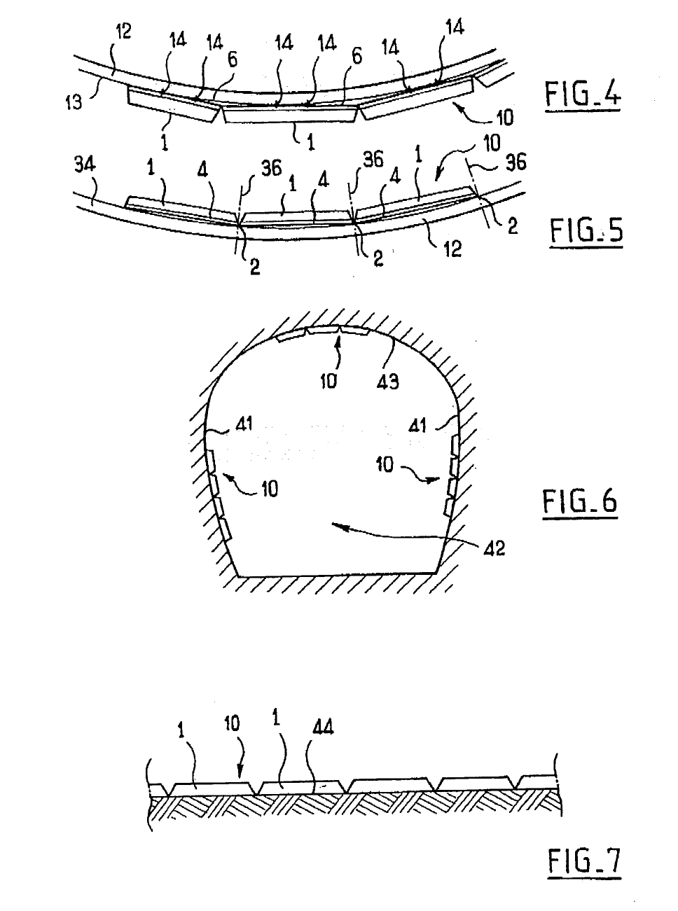

FIG. 4 is a detail view of the implementation according to FIG. 3, with the beam being in the deformed condition;

FIG. 5 is a view similar to FIG. 4 but with a detector mounted upon the top of the beam;

FIG. 6 is a cross-sectional view of a tunnel equipped with a detector according to the invention; and

FIG. 7 is a view of the detector according to the invention positioned onto a ground the geometry of which is to be monitored.

The differential bending and/or subsidence detector 10 according to the invention comprises a sequence of elements 1 which are connected to each other by links 2. The axes 3 of the links 2 are parallel to each other and perpendicular to the direction along which the elements 1 are in sequence.

Each element 1 comprises the base 4 having a generally planar shape. The linking axes 3 are located substantially in the plane of the bases 4 and allow the bases 4 to be mutually aligned. The bases 4 can be therefore altogether applied, by their lower bearing surface 6, against a planar surface of a structure which is liable to bend.

Each element 1 has the general shape of a L-profile, one of the flanges of which is constituted by the base 4. The other flange 7 of the L-profile stands from the base 4 along a direction extending away from the hearing surface 6. The flanges 7 are coplanar. They have end edges 8 which are oblique with respect to the plane of the respective base 4 so as to form between both mutually facing edges 8 of two adjacent elements 1 a recess 9 which exhibits a V-shape when the bases 4 are coplanar. This enables elements 1 to pivot with respect to each other about the linking axes 3 even in the direction where the end edges move toward each other starting from the situation where the bases 4 are coplanar.

Each base 4 comprises a means for securing element 1 against the surface of the structure. In the example which is shown, each base 4 comprises to this end two holes 11 which are located in an intermediate position between the longitudinal ends of the element, and with a certain distance between them as measured parallel to the direction along which the elements are in sequence. Preferably, the set of holes 11 of each element is located at an equal distance between both ends of the element and so as to exhibit between them a relatively small spacing by comparison with the length of this element.

As shown in FIG. 4, this allows to secure the elements to the structure, here a beam 12, by applying the bearing face 6 of the base 4 against the surface 13 of the structure which is convex, or liable to become convex under the action of bending.

To this end, securing means 14 are used, which are not shown in detail but which may be screw bolts.

Thanks to the two securing means which respectively correspond to each one of the holes 11 of each element the bearing face 6 of the base 4 is maintained substantially tangent to the surface 13 in the middle of each element. This ensures that the sequence of the bases 4 reproduces rather faithfully, in the form of a broken line, the curvilinear profile of the surface 13. As a consequence, the elements are not intended to bend with the structure. Their L-profile shape contributes to avoiding that they bend.

It may happen that for certain applications, the detector has to be mounted onto non-planar surfaces or, else, onto surfaces which should be planar but which exhibit deficiencies in their evenness. To this end, as shown in FIG. 1, the base 4 may possess one or more adjustable bearing means 16, (only one is shown, on one of the elements), each consisting e.g. of a screw 17 which can be more or less screwed into a threaded bore of the base 4 so that its bearing end 18 adjustably protrudes onto the surface 6. In operation the bearing means 16 are adjusted so that each element rests in a stable manner onto the structure.

Means 19 for detecting the angular deflection between successive elements 1 are mounted so that a body 21 secured to the flange 7 of an element 1 and a motion-sensing end 22 is secured to the flange 7 of the adjacent element 1. The locations of both flanges 7 where the body 21 and the end 22 are secured, respectively, are selected so that the line 23 along which the displacement is detected extends at a distance from the axis 3 of the corresponding link 2, in other words so that the line 23 and the axis 3 do not intersect each other.

There is thus detected the angular deflection between the adjacent elements 1 by detecting the variation in the distance between the adjacent elements along the line 23.

The detection means 19 is preferably a sensor according to DE 39 02 997 or to the Japanese patent application filed under number JP 6-291 249. According to these documents, an optical fibre forms a loop about two blocks mounted within the casing 21, one being stationary with respect to the casing and the other being mounted onto a slide which is integral with the sensor extremity 22. The loop sections extending between both blocks form a sinuous shape, the curvature of which varies when the distance varies between the casing 21 and the sensor end 22. One of the end 24 of the optical fibre is fed from a light source 26. The other extremity 27 of the optical fibre is connected to a means 28 for detecting the light intensity which is received. When the relative angular position of two successive elements 1 changes, the sensor end 22 moves with respect to the casing 21 of the corresponding sensor 19. This causes a variation of the curvature of the sinuous section(s) of the optical fibre in the casing 21 and this in turn modifies the light attenuation in the optical fibre. This modification of the attenuation is detected in apparatus 28.

The light intensities detected in apparatus 28 are transmitted, for example in a digital form, to a processing unit 29 which may for example display the deformed profile 32 of the surface 13 of the structure on a screen 31, or, further, provide results in the form of values, e.g. measurements of the deflection at different locations of the length of the surface 13, or, still further, corresponding amounts of stress.

FIG. 2 shows that device according to the invention can be secured very quickly to the structure 12 by means of mere clamps (33), for example one for each element (1) of the detector. It has been possible to mount the detector in a few tens of seconds.

FIG. 3 shows that the elements 1 can be of very different length with respect to each other. It is possible to place very short elements 1 in an area where high amounts of strain are expected, or where large variations of the strain between locations which are close to each other, are expected, for example in the vicinity of a pole supporting the beam 12 or of a load applied to the beam 12. FIG. 3 also shows that detector 10 may extend over part only on the beam 12 or other structure to be monitored. It is for example possible to position the detector 10 in an area which is liable to be the most stressed area. It is also possible that the deformations of the remainder of the beam 12 can be deducted from the deformations of the area which is associated with the detector, by extrapolation.

FIG. 5 shows that the detector 10 may as well be located onto a surface 34 which is concave or liable to become concave under the effect of the strain. In such a case, it is preferred to secure the elements 1 by means 36 which are not shown in detail, but which coincide with the links 2. This allows the area of the elements 1 and more specifically the area of the bases 4 which is far away from their links 2, to move apart, as far as needed, from the surface 34, depending on the concavity.

In any case of mounting, the mounting is always such that the linking axes 3 are substantially parallel to the axis of the curvature produced by the expected strain or deformation.

In the example shown in FIG. 6, the detectors 10 have been positioned against the inner face of the side walls 41 of a tunnel 42 and against the under face 43 of the vault of the tunnel, in each case along the inner transverse profile of the tunnel

In the example of FIG. 7, the detector 10 is positioned onto a ground 44 for detecting a possible differential subsidence. The detector 10 rests onto the ground by gravity that is to say by its own weight. The elements may be realised relatively heavy for providing a good coupling between each element 1 and that part of the ground 44 onto which the element 1 rests. In this embodiment and mode of implementation of the method, the detector does not need to be provided with securing means.

Of course the invention is not limited to the described and represented examples.

Although the movement detection between the elements by an optical way is preferred for its great reliability and its great insensibility to parasites, any other detection mode for the angular deflection between elements may be contemplated.

The links may be replaced by false-links, for example in the form of resiliently flexible connexions.

1. A differential bending and/or subsidence detector, characterised by comprising:
a sequence of at least two elements (1) connected to each other by linking means (2), said sequence being intending to match a profile of a surface (13, 34) of the structure (12) the differential bending and/or subsidence of which is to be detected; and
a detection means (19) for detecting the relative angular deflection between adjacent elements (1).

2. A detector according to claim 1, characterised in that the detection means (19) for detecting the angular deflection comprises means for detecting the distance between two points each of which is part of one of said two elements, said two points being positioned on a line (23) extending at a distance from the axis (3) of the linking means (2).

3.- A detector according to claim 2, characterised in that the distance detection means (19) comprises at least one optical fibre (24, 27) mounted operatively between said two points.

4.- A detector according to one of claims 1-3, characterised in that each element (1) comprises a fixing base (4) and a flange (7) standing from the base, in that the linking means (2) connect the elements (1) in the virinity of their bases (4), and in that the means (19) for detecting the angular deflection are connected to the flanges (7) of the elements.

5.- A detector according to one of claims 1-4, characterised in that said detector comprises means (11) for securing each element to the structure, said means for securing being positioned at an intermediate position between the ends of the elements.

6.- A detector according to claim 5, characterised in that the securing means (11) are arranged for tangentially applying the elements (1) against the surface (13) of the structure (12).

7.- A detector according to claim 5 or 6, characterised in that the securing means comprise two individual means (11) which are spaced apart substantially along the direction along which the elements are in sequence

8.- A detector according to one of claims 1-7, characterised in that said detector comprises means (36) for securing the sequence of elements (1) in the region of the linking means (2) between adjacent elements (1).

9.- A detector according to one of claims 1-8 characterized in that the elements (1) are of at least two different lengths as measured along the direction along which the elements are in sequence.

10.- A detector according to one of claims 1-9, characterised in that at least one of the elements (1) comprises adjustable bearing means (16) for stabilising its bearing on the surface of the structure (12).

11.- A method for monitoring the differential bending and/or subsidence of a structure, characterised by positioning along at least part of a surface (13, 34) of the structure (12) several successive elements (1) connected to each other by linking means (2), and detecting angular deflections between successive elements.

12.- A method according to claim 11, characterised in that a step of positioning the detector un a surface (13) which is liable to be convex comprises a step of the elements (1) so that their intermediate region is substantially tangent to the surface (13).

13.- A method according to claim 12, characterised by the step of securing each element (1) by way of two securing means (14) which are substantially aligned along the direction along which the elements (1) are in sequence

14.- A method according to claim 11, characterised by the step of securing the sequence of elements (1) to the structure (12) in the vicinity of the linking means (2).

15.- A method according to one of claims 11-14, characterised by the step of associating the sequence of elements (l) with the surface (13, 34, 44) by using quick clamping means, such as clamps (33), or by causing the sequence of elements (1) to be pressed by gravity onto the surface (44).
